(19) United States
(12) Patent Application Publication
(10) Pub. No.: US 2023/0358553 A1
(43) Pub. Date: Nov. 9, 2023

(54) INFORMATION PROCESSING APPARATUS AND TRAVEL ROUTE DETERMINATION METHOD

(71) Applicant: SONY GROUP CORPORATION, TOKYO (JP)

(72) Inventors: TOSHIO YAMAZAKI, TOKYO (JP); GUIFEN TIAN, TOKYO (JP); MAKOTO DANIEL TOKUNAGA, TOKYO (JP); YASUHIRO YUKAWA, TOKYO (JP)

(21) Appl. No.: 18/245,894

(22) PCT Filed: Sep. 27, 2021
(86) PCT No.: PCT/JP2021/035297

§ 371 Date: Mar. 19, 2023

(30) Foreign Application Priority Data
Oct. 7, 2020 (JP) 2020-170003

(51) Int. Cl. G01C 21/34

(52) U.S. Cl. CPC G01C 21/3461; G01C 21/3492

(57) ABSTRACT

A more desirable travel route for a user is set. An information processing apparatus includes: an information acquisition unit (18) configured to acquire road information on each of two or more travel routes to a destination; a priority acquisition unit (23) configured to acquire priority of driving means in accordance with the road information; and a selection unit (11) configured to select one of the two or more travel routes on the basis of the road information and the priority.

### FIELD

The present disclosure relates to an information processing apparatus and a travel route determination method.

### BACKGROUND

Based on recent development of a sensor technology, a technology for implementing automatic driving of a vehicle, or the like, has been proposed and put into practical use. A navigation technology for guiding an own vehicle to a destination is one of important technologies for implementing automatic driving.

### CITATION LIST

### Patent Literature

Patent Literature 1: JP 2017-72440 A

Patent Literature 2: JP 2018-194343 A

### SUMMARY

### Technical Problem

In a navigation technology in related art, manual driving is assumed, and thus, it is sufficient if an appropriate travel route from a current position to a destination can be indicated to a driver. However, in a case where an automatic driving technology and the navigation technology are combined, there is a problem that a travel route after change is not necessarily a desirable travel route for a user because a perfect automatic driving technology has not yet been implemented.

The present disclosure has been made in view of the above, and an object of the present disclosure is to provide an information processing apparatus and a travel route determination method that enable setting of a more desirable travel route for a user.

### Solution to Problem

To solve the problems described above, an information processing apparatus includes: an information acquisition unit configured to acquire road information on each of two or more travel routes to a destination; a priority acquisition unit configured to acquire priority of driving means in accordance with the road information; and a selection unit configured to select one of the two or more travel routes on a basis of the road information and the priority.

### BRIEF DESCRIPTION OF DRAWINGS

FIG. 1 is a view for explaining an example of an information processing apparatus according to an embodiment.

FIG. 2 is a view for explaining an example of a configuration of the information processing apparatus according to the embodiment.

FIG. 3 is a flowchart illustrating processing procedure of travel route determination processing according to the embodiment.

FIG. 4 is a flowchart illustrating processing procedure of setting an attribute value by a user according to the embodiment.

FIG. 5 is a view illustrating an attribute value setting screen according to the embodiment.

FIG. 6 is a view illustrating an attribute value setting screen according to the embodiment.

FIG. 7 is a flowchart illustrating processing procedure of travel route determination processing according to the embodiment.

FIG. 8 is a view indicating map data according to the embodiment in a graph structure.

FIG. 9 is a view indicating the map data according to the embodiment in a graph structure.

FIG. 10 is a flowchart illustrating processing procedure of updating a travel route according to the embodiment.

FIG. 11 is a flowchart illustrating processing procedure of updating the travel route according to the embodiment.

### DESCRIPTION OF EMBODIMENTS

Hereinafter, preferred embodiments of the present disclosure will be described in detail with reference to the accompanying drawings. Note that, in the present specification and the drawings, components having substantially the same functional configuration will be denoted by the same reference numerals, and redundant description will be omitted.

The present disclosure will be described according to the following order of items.
1. One Embodiment
1.1. Hardware Configuration
1.2. Functional Configuration
1.3. Outline of Usage Method
1.4. Description of Operation (Flowchart)
2. Other Embodiments

### 1. One Embodiment

First, as one embodiment, an example of travel route updating means using an information processing apparatus to be mounted on a vehicle, or the like, will be described.

1.1. Hardware Configuration

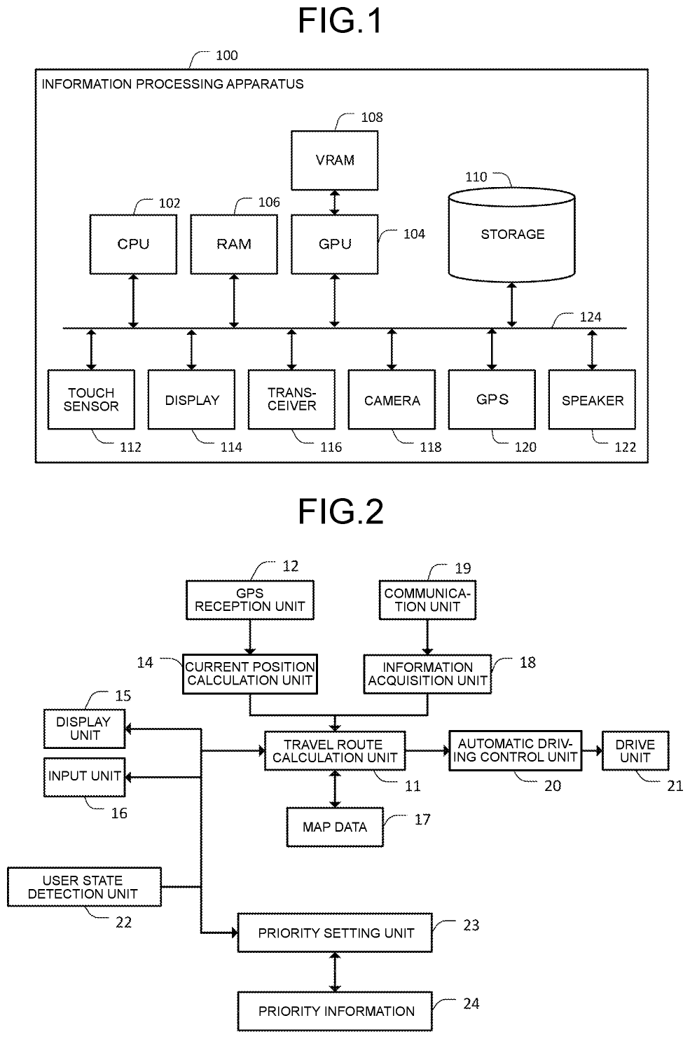

FIG. 1 is a view illustrating an example of a hardware configuration diagram of an information processing apparatus 100 according to the present embodiment. The information processing apparatus 100 according to the present embodiment includes a central processing unit (CPU) 102, a graphics processing unit (GPU) 104, a random access memory (RAM) 106, a video RAM (VRAM) 108, a storage 110, a touch sensor 112, a display 114, a transceiver 116, a camera 118, a global positioning system (GPS) receiver 120, a speaker 122, and the like, which are connected via a bus 124.

In the present embodiment, the CPU 102 is an arithmetic apparatus that performs various calculations. For example, the CPU 102 copies a program stored in the storage 110 to the RAM 106 and executes the program. The CPU 102 may be part of an integrated circuit constituting a system on a chip (SoC) provided on a control board.

The CPU 102 also controls an image to be displayed on the display 114. For example, a command for displaying an image recorded in the VRAM 108 on the display 114 is issued to the GPU 104, and the image is displayed on the display 114.

The CPU 102 also controls various devices such as the GPU 104, the RAM 106, the VRAM 108, the storage 110, the touch sensor 112, the display 114, the transceiver 116, the camera 118, the GPS receiver 120, and the speaker 122, and processes inputs from the various devices.

In the present embodiment, the GPU 104 is an arithmetic apparatus mainly intended to execute arithmetic operation for image processing and executes arithmetic operation in response to a command from the CPU 102 as described above. Similarly to the CPU 102, the GPU 104 may also be part of an integrated circuit constituting a system on a chip (SoC) provided on the control board.

In the present embodiment, the RAM 106 is a main storage apparatus to be used as a work area when the CPU 102 executes a program. Similarly to the CPU 102, the RAM 106 may also be part of an integrated circuit constituting a system on a chip (SoC) provided on the control board.

In the present embodiment, the video RAM (VRAM) 108 is a main storage apparatus to be mainly used as a work area when the above-described GPU 104 performs arithmetic operation for image processing. The VRAM 108 may be a unified memory architecture (UMA) that is a configuration shared with the RAM 106 described above.

In the present embodiment, the storage 110 includes, for example, an auxiliary storage apparatus such as a hard disc drive (HDD) and a flash memory.

The touch sensor 112 in the present embodiment has a function of detecting contact by the user. The touch sensor 112 may be, for example, a capacitive or pressure-sensitive touch sensor. The touch sensor 112 can detect contact action such as touching, stroking, hitting, or pushing by the user and can perform operation in accordance with the contact action. The touch sensor 112 may be provided integrally with the display 114 of the information processing apparatus 100.

The display 114 according to the present embodiment presents an image generated by the GPU 104, or the like, to be visible to the user and is implemented by, for example, a liquid crystal display, an organic electro-luminescence (EL) display, or the like.

The transceiver 116 in the present embodiment is an apparatus for transmitting and receiving information. For example, the transceiver 116 transmits and receives information via the Internet, or the like, using wired communication or wireless communication.

The camera 118 in the present embodiment includes at least a lens, an image sensor (CMOS, CCD, etc.), and a color filter. The camera may be a visible light camera, an infrared camera using an infrared filter instead of a color filter, or a visible light camera and an infrared camera may be provided together. In addition, a visible light source or an infrared light source may be provided so that an image of an imaging object can be captured even in an environment where an amount of light is insufficient. Infrared light may also be projected in a given projection pattern to measure a distance to the object.

The GPS receiver 120 in the present embodiment acquires a satellite signal for estimating a current position of the information processing apparatus 100. The GPS receiver 120 receives signals from a plurality of satellites. The received signals are recorded in the RAM 106 via the bus 124.

The speaker 122 in the present embodiment is an apparatus that emits sound. For example, the speaker 122 receives sound on the RAM 106 via the bus 124 on the basis of a command from the CPU 102 and emits the received sound at a given volume.

1.2. Functional Configuration

FIG. 2 is a block diagram illustrating a functional configuration according to the present embodiment. The information processing apparatus 100 in the present embodiment illustrated in FIG. 1 determines a travel route of a vehicle when driving.

In the present embodiment, the information processing apparatus 100 includes a travel route calculation unit 11, a current position calculation unit 14 equipped with a GPS reception unit 12, a display unit 15 and an input unit 16 that receive inputs from a driver (or a fellow passenger, hereinafter also referred to as a user) and perform display, a user state detection unit 22 that detects a user state, a map data acquisition unit 17 that acquires information on a road map (hereinafter, referred to as map data), a communication unit 19 and an information acquisition unit 18 for receiving traffic information and road information, a drive unit 21 for driving an automobile and an automatic driving control unit 20 that controls the drive unit, a priority setting unit 23, and priority information 24.

The travel route calculation unit 11 is implemented by, for example, the CPU 102 of the information processing apparatus 100. The travel route calculation unit 11 obtains a travel route from the current position to a destination from the destination input from the input unit 16, the current position acquired from the current position calculation unit 14, the road information transmitted from the information acquisition unit 18 which will be described later, and the map data acquired via the map data acquisition unit 17.

Note that the travel route calculation unit 11 may calculate the travel route using other information in addition to the destination, the current position, the road information, and the map data or may calculate the travel route on the basis of less information than these. For example, the travel route calculation unit 11 may calculate the travel route using a user state detected by a user state detection unit 22 which will be described later in addition to the destination, the current position, the road information, and the map data.

The map data acquisition unit 17 may acquire the map data stored in a storage unit (for example, the storage 110 in FIG. 1) in the information processing apparatus 100 or may acquire the map data via a network such as a mobile communication network (including inter-vehicle communication).

The user state detection unit 22 detects the user state by sensing the user with a sensor such as the camera 118 of the information processing apparatus 100. For example, the user state detection unit 22 may capture an image of the user with the camera 118 of the information processing apparatus 100 and analyze the captured image with the CPU 102 to detect a posture, a line-of-sight direction, an awakening state (eyelid opening, blinking frequency, and the like), and the like, of the user as the user state.

The input unit 16 is implemented by the touch sensor 112, or the like, of the information processing apparatus 100. The current position calculation unit 14 is implemented by the CPU 102, or the like, of the information processing apparatus 100. The storage 110 stores the map data, a program for causing the CPU 102 to execute each unit illustrated in FIG. 2, and the like, as necessary.

The travel route obtained by the travel route calculation unit 11 is used for control of the drive unit 21 by the automatic driving control unit 20. In a case where a section in which the vehicle is traveling is a section in which automatic driving of a level 3 or higher is set, the automatic driving control unit 20 causes the vehicle to travel by controlling the drive unit 21 on the basis of the travel route.

The GPS reception unit 12 receives signals from a plurality of satellites at a given timing and transfers the received signal information to the current position calculation unit 14. The GPS reception unit 12 may be implemented by, for example, the GPS receiver 120 of the information processing apparatus 100.

If the satellite signals are received from the GPS reception unit 12, the current position calculation unit 14 calculates the current position of the whole apparatus including the GPS reception unit 12 on the basis of the received satellite signals. The current position calculation unit 14 that has acquired the current position transmits the current position to the travel route calculation unit 11 so that the travel route calculation unit 11 can use the current position. The current position calculation unit 14 may be implemented by, for example, the CPU 102 of the information processing apparatus 100.

The communication unit 19 receives road information related to traffic information, road conditions, and the like. In other words, information measured by a measuring instrument, or the like, installed on a road or accident information, or the like, stored in a server in which accident information, or the like, is accumulated is acquired via a network such as a mobile communication network. The communication unit 19 may be implemented by, for example, the transceiver 116 of the information processing apparatus 100.

Note that the traffic information may include traffic congestion information of roads, accident information, information related to traffic regulations due to construction, and the like, and the road conditions may include information related to road conditions such as whether or not the road is paved, whether or not a road surface is frozen, whether or not the road is covered with snow, whether or not the road is covered with water, and the like, in addition to information such as a road width, the number of lanes, the number of traffic signals, intersections, and the like, of the road. In addition to the traffic information and the road conditions described above, the road information may include information such as weather (fog, rain, snow, thunderstorm, etc.) and a temperature on the road, and the number of stores such as convenience stores and road stations.

The information acquisition unit 18 acquires the traffic information and the road information received by the communication unit 19. The information acquisition unit 18 that has acquired the road information, and the like, transmits the road information, and the like, to the travel route calculation unit 11 so that the travel route calculation unit 11 can use the road information, and the like. The information acquisition unit 18 may be implemented by, for example, the CPU 102 of the information processing apparatus 100.

The display unit 15 displays the map information to the user. The display may be, for example, the display 114 of the information processing apparatus 100.

The priority setting unit 23 sets priority of driving means. The priority of the driving means includes, for example, a setting item for reflecting preference as to whether the user prioritizes manual driving or automatic driving. Specifically, for example, preference of the user such as preference that the user does not want to perform manual driving in a case where the road conditions are bad or preference that the user wants to perform manual driving regardless of whether or not the road conditions are good may be set, and the set preference of the user may be reflected in the traveling.

Note that the priority setting unit 23 may implement setting of the priority of the driving means including a setting item for reflecting the user's preference by the user touching the touch sensor 112 of the information processing apparatus 100, for example.

The priority information 24 is information on the priority of the driving means set by the priority setting unit 23. The priority information 24 may be stored in the storage 110 of the information processing apparatus 100, for example.

The automatic driving control unit 20 may be, for example, an electronic control unit (engine control unit or electronic control unit). The automatic driving control unit 20 causes the vehicle to travel along the travel route by controlling the drive unit 21 on the basis of the travel route calculated by the travel route calculation unit 11 while traveling in the automatic driving section.

1.3. Outline of Usage Method

Outline of a method of using the information processing apparatus 100 mounted on the vehicle in the present embodiment will be described below.

The information processing apparatus 100 is activated, for example, by the user pressing an engine start switch of the vehicle. If the information processing apparatus 100 is activated, the travel route calculation unit 11 acquires map data via the map data acquisition unit 17, acquires current position information of the vehicle specified by the current position calculation unit 14 on the basis of the satellite signals received by the GPS reception unit 12 and displays a map image around the own vehicle on the display unit 15 on the basis of the current position information. For example, the user operates the input unit 16 to set a destination in the travel route calculation unit 11.

The travel route calculation unit (also referred to as a selection unit) 11 searches for one or more travel routes to the destination from the map data, the current position information, and the destination. Then, the travel route calculation unit 11 causes the display unit 15 to display the searched one or more travel routes as travel routes on the map data. In a case where a plurality of travel routes are presented to the user as a result of the search, the user may select one travel route via the input unit 16.

If the travel route is determined in this manner, the travel route calculation unit 11 starts navigation along the determined travel route. In determining the travel route, the travel route calculation unit 11 also determines driving means (automatic driving or manual driving) for each section constituting the travel route. In a case where the current traveling position on the travel route is within a section where the automatic driving is set, the travel route calculation unit 11 inputs information (hereinafter, referred to as travel control information) for causing the vehicle to travel along the travel route to the automatic driving control unit 20. In response to this, the automatic driving control unit 20 starts automatic driving of the vehicle along the travel route by controlling the drive unit 21 on the basis of the travel control information input from the travel route calculation unit 11.

In a case where the road information acquired by the information acquisition unit 18 from the content received by the communication unit 19 includes, for example, information indicating that an accident, or the like, has occurred at a place where the vehicle is scheduled to pass on the travel route while the vehicle is traveling under the control of automatic driving, the travel route calculation unit 11 re-searches the travel route from the current position of the vehicle at that time to the destination.

In a case where there is a plurality of candidates for the travel route as a result of the re-search, the travel route calculation unit 11 calculates the travel route to be selected. In this event, a negative score is calculated for each of the travel routes on the basis of the map data, the road information for each of the travel routes, and the priority information 24 set by the priority setting unit 23, and the current travel route is updated using a route having the lowest negative score (travel route positive for driving) as a new travel route.

Note that the negative score is an index obtained by quantifying that the user does not desire manual driving and can take a value range from 0 to 1, for example. If the negative score, for example, is closer to ‘0’, it indicates that the user is positive for manual driving (that is, the user considers that manual driving may be performed), and if the negative score is closer to ‘1’, it indicates that the user is negative for manual driving (that is, the user considers that manual driving is not desired).

The travel route calculation unit 11 inputs travel control information to the automatic driving control unit 20 on the basis of the new travel route updated in this manner. On the other hand, the automatic driving control unit 20 starts automatic driving of the vehicle along the new travel route by controlling the drive unit 21 on the basis of the travel control information input from the travel route calculation unit 11.

Note that, in the first travel route search after the user gets on the vehicle, the travel route is determined on the basis of the map data and the current position in the above-described usage method. However, the travel route may be determined on the basis of the road information acquired via the communication unit 19 and the information acquisition unit 18. Further, the travel route may be determined on the basis of the priority information 24 set by the priority setting unit 23.

1.4. Description of Operation (Flowchart)

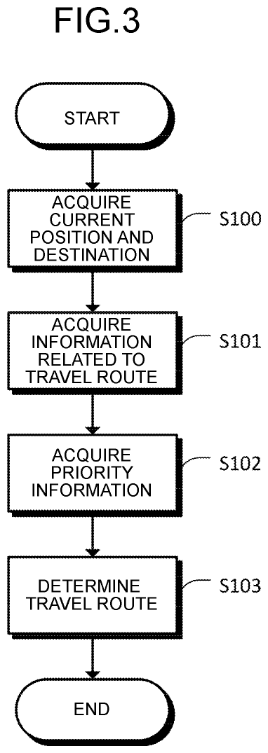

Next, travel route determination processing and travel route update processing to be executed by the travel route calculation unit 11 will be described with reference to a flowchart illustrated in FIG. 3.

In step S100, the travel route calculation unit 11 uses the CPU 102 to read the map data from the storage 110, develops the map data in the RAM 106, and then displays a map image based on the map data on the display unit 15 so as to be visible to the user. Thereafter, an input of a destination is received through operation of the input unit 16 by the user. Further, the current position is acquired from the current position calculation unit 14. If the travel route calculation unit 11 finishes execution of step S100, the processing proceeds to step S101.

In step S101, the travel route calculation unit 11 acquires the road information on the travel route from the current position to the destination from the information acquisition unit 18. The information acquired here is desirably information that affects automatic driving. For example, examples of the information can include road conditions (bad road, state where the road is frozen, snow coverage, etc.), weather (fog, rain, snow, thunderstorm, etc.), changed road information (regulation information, number of lanes, change of traffic regulations due to construction, etc.), and the like.

Table 1 indicates the acquired road information in a table. The road information is table data of a set of an attribute name and a value thereof. For example, there are large and small classifications as indicated in the table. For example, a value of the road information in the small classification “distance” in the large classification “distance and time” is NS51, and a value of the small classification “rain” in the large classification “weather” is NS42. The values from NS11 to NS52 are negative scores (hereinafter, referred to as a negative score before correction) for driving before being weighted on the basis of the priority information 24 of the user and take a value range from 0 to 1. A case of 0 indicates positive for driving, and a case of 1 indicates negative for driving.

TABLE 1

| Large classification | Small classification | Value |
|---|---|---|
| Road conditions | Bad road | NS11 |
| | Whether or not there is pavement | NS12 |
| | Whether or not there is bike lane | NS13 |
| | Frozen road | NS14 |
| | Snow coverage | NS15 |
| Road type | Toll road | NS21 |
| | Expressway | NS22 |
| | Limited highway | NS23 |
| Traveling difficulty | Road width, the number of lanes | NS31 |
| | Whether or not there is junction | NS32 |
| | State of road shoulder (such as there | NS33 |
| | is no cover on drainage channel) | |
| | Straightness (few carves) | NS34 |
| Weather | Fog | NS41 |
| | Rain | NS42 |
| | Snow | NS43 |
| Distance and time | Distance | NS51 |
| | Time | NS52 |

For example, in a case where the acquired road information includes information indicating that snow is piled on the travel route, the negative score before correction NS43 in the large classification “weather” and the small classification “snow” is a high value assuming that the road surface state is unsuitable for driving. Conversely, in a case where the acquired road information includes information indicating that snow is not piled on the travel route, a value of NS43 becomes low assuming that a road surface state is suitable for driving.

The negative scores before correction from NS11 to NS52 include a value (large classification “weather”, or the like) depending on a timing at which the road information is acquired and a value (large classification “road type”, or the like) that does not depend on or is unlikely to depend on the timing at which the road information is acquired.

If the travel route calculation unit 11 finishes the processing of step S101, the processing proceeds to step S102.

In step S102, the travel route calculation unit 11 acquires the priority information 24 that has been input by the user from the priority setting unit 23.

If the travel route calculation unit 11 finishes the processing of step S102, the processing proceeds to step S103.

In step S103, the travel route calculation unit 11 determines the travel route on the basis of the information, and the like, acquired in the previous steps and ends the process.

Subsequently, the priority information 24 acquired in step S102 will be described. Here, the priority information 24 is data including data obtained by quantifying the user's preference of whether manual driving or automatic driving is good in traveling on the road.

An example of the priority information 24 is indicated in Table 2. The priority information 24 is a table including a set of an attribute name and a value thereof (hereinafter, weight). A number of attribute names are conceivable as the attribute names, and thus, management becomes difficult as the number of attributes increases. Thus, the attribute names may have a hierarchical structure. In Table 2, the attribute names are managed by the attributes of the large and small classifications.

TABLE 2

| | | |
|---|---|---|
| Large classification | Small classification | Weight |

| | |
|---|---|
| Road conditions | W1 |
| Road type | W2 |
| Traveling difficulty | W3 |
| Weather | W4 |
| Distance and time | W5 |

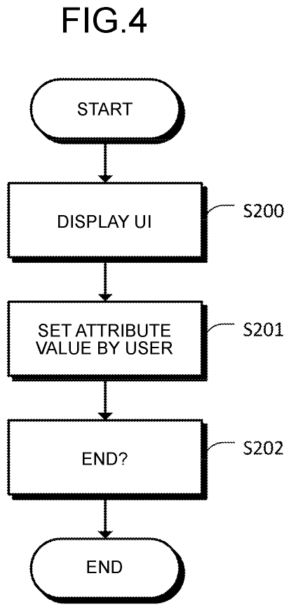

The priority setting unit 23 that sets the priority information 24 will be described with reference to a flowchart of FIG. 4.

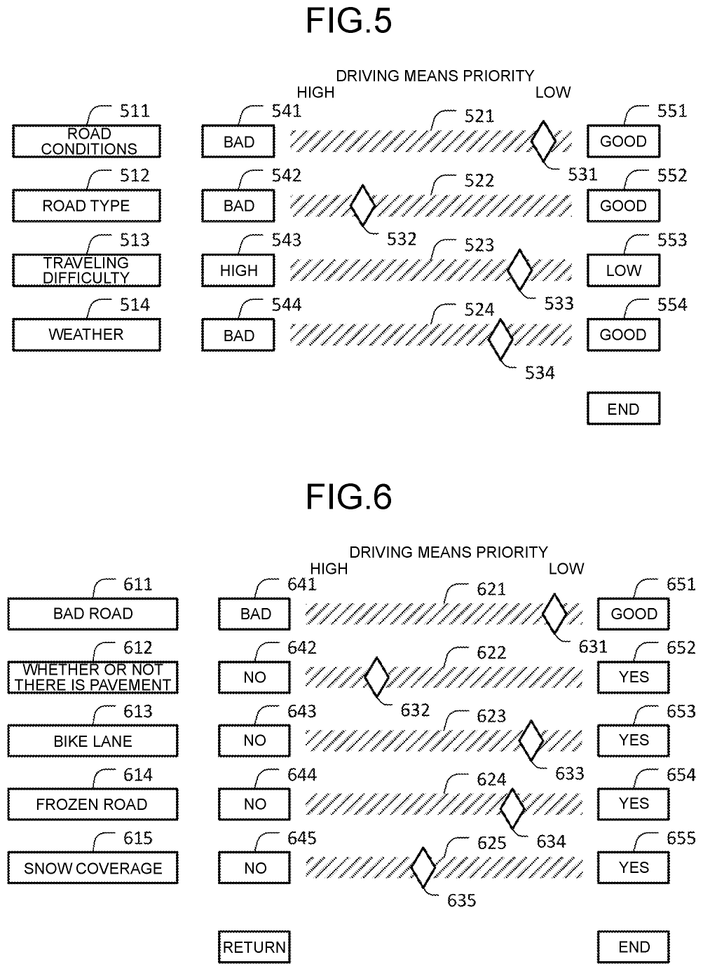

The priority setting unit 23 displays the priority information 24 to be set on the display unit 15 in step S200. FIG. 5 illustrates a display example in a case where the touch sensor 112 as the input unit 16 is integrated with the display 114 as the display unit 15. The priority setting unit 23 displays attribute names 511 to 514 that can be set, good 551 to 554 for the attributes, and bad 541 to 544 for the attributes, and operable slider bars 521 to 524 for values setting so that the user can set the priority of the driving means such as the user's preference.

The slider bars 521 to 524 have a function of setting a state of each attribute value and priority of manual driving at the time of the state. In FIG. 5, the manual driving priority is increased by moving knobs 531 to 534 of the slider bars 521 to 524 to the bad side, and the manual driving priority is lowered by moving the knobs to the good side.

The weight of the table of attribute values obtained by moving the knobs 531 to 534 of the slider bars 521 to 524 is increased or decreased using the slider bar value designated by the user in step S201 as a weight. For example, in a case where the knob 531 of the slider bar 521 of the large classification “road conditions” is moved in a high (bad) direction, the weight W1 of the large classification “road conditions” of the attribute values of the road conditions indicated in Table 2 is increased. Conversely, in a case where the knob 531 is moved in a low (good) direction, W1 is decreased.

Furthermore, for example, in a case where it is desired to set the value of the small classification of the large classification “road conditions”, for example, the slider bar may be switched as illustrated in FIG. 6, and the knobs 631 to 635 of the slider bars 621 to 625 of items of the small classification may be moved to make the setting possible. In this case, a table of attribute values for the respective items of the small classifications is as indicated in Table 3.

TABLE 3

| Large classification | Small classification | Weight |
|---|---|---|
| Road conditions | Bad road | W11 |
| | Whether or not there is pavement | W12 |
| | Whether or not there is bike lane | W13 |
| | Frozen road | W14 |
| | Snow coverage | W15 |

The weight increases in a case where manual driving is desired to be prioritized and decreases in a case where manual driving is not desired to be prioritized (automatic driving is desired to be prioritized), and the value thereof is 0 weight 1. Of course, this value is a coefficient, and thus, the value does not have to be this value, and if 1 is subtracted from the weight and inverted, the value can have the opposite meaning.

In step S202, the user sets end of setting, and the setting ends.

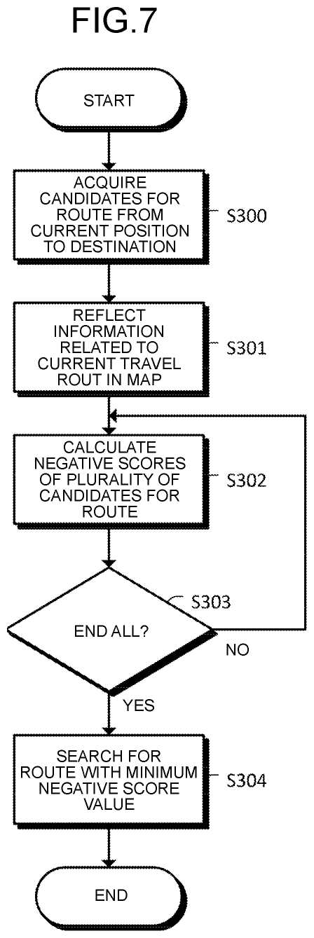

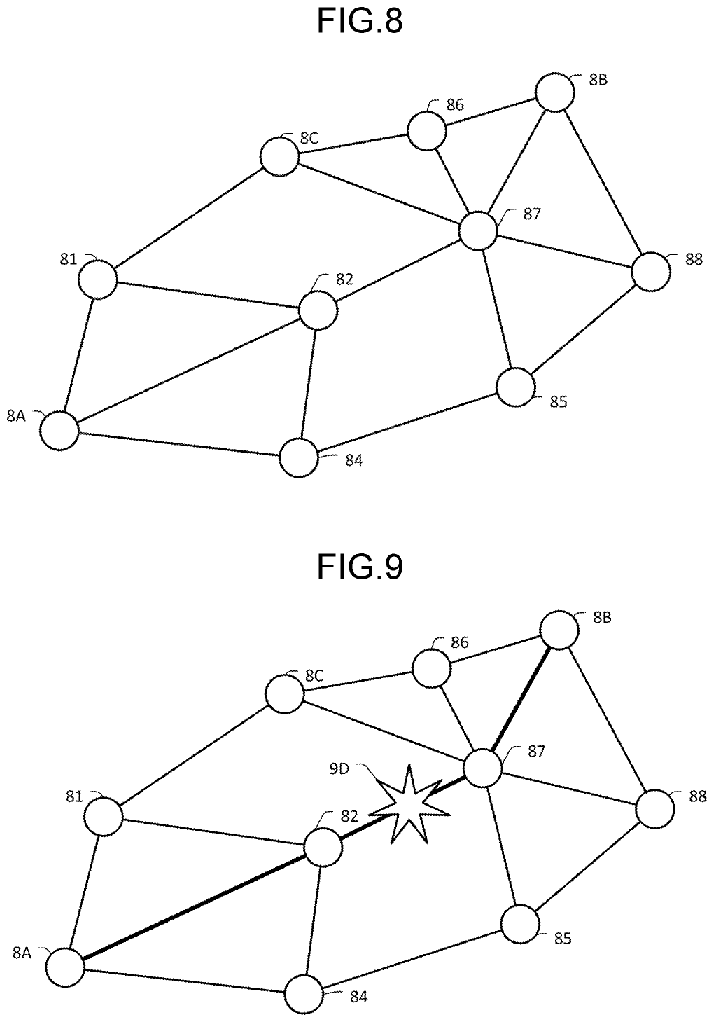

Next, the travel route determination processing to be performed in step S103 will be described with reference to the flowchart of FIG. 7.

The travel route calculation unit 11 first acquires candidates for the travel route from the current position to the destination via the map data acquisition unit 17 in step S300. In the present embodiment, the map data is represented by a graph structure as illustrated in FIG. 8. The map data has a structure in which intersections illustrated in FIG. 8 and roads (hereinafter, also referred to as nodes) are connected, and a travel route on which the vehicle can travel is connected. In addition, the map data corresponds to an actual map.

The road information of the travel route indicated in Table 1 is added to each road and intersection. This is a table that stores the negative scores before correction that are values obtained by quantifying the attributes of the roads and the intersections as described above.

In step S301, the travel route calculation unit 11 acquires, from the information acquisition unit 18, the road information, for example, weather information, road conditions, and the like, that affect the travel route information added to the roads and the intersections of the candidates for the travel route. After the acquisition, the road information of the travel route of each road and intersection is updated according to the information.

In step S302, the travel route calculation unit 11 calculates negative scores of a plurality of candidates for the travel route. This corresponds to preprocessing of narrowing down the candidates for the travel route.

For example, considering a travel route from a current position 8A to a destination 8B in FIG. 8, a plurality of candidates for the travel route is conceivable. In a case of FIG. 8, 8A→81→8C→86→8B, 8A→82→87→8B, or the like, is conceivable.

In related art, for example, a route with the shortest distance or a route with the shortest traveling period is determined. In the present embodiment, a negative score of each travel route is calculated to perform preprocessing of narrowing down the candidates for the travel route.

In the calculation of the negative score, in each travel route, negative score values of the same attribute are multiplied by weight for the table of the negative score before correction of the road information of the travel route and the table of the weight of the priority information 24 set by the priority setting unit 23, and all the multiplication results for each attribute are added. The added value is set as a negative score value of the travel route.

Tables 4 and 5 are respectively excerpts of tables of negative scores before correction of road information of a certain travel route and weight of the priority information 24 set by the priority setting unit 23. Here, in the calculation of the negative score, NS31×W31+NS32×W32+NS33×W33+NS34×W34 is calculated. The same applies to portions other than the extracted tables.

TABLE 4

| Large classification | Small classification | Value |
|---|---|---|
| Traveling difficulty | Road width, the number of lanes | NS31 |
| | Whether or not there is junction | NS32 |
| | State of road shoulder (such as there is | NS33 |
| | no cover on drainage channel) | |
| | Straightness (few carves) | NS34 |

TABLE 5

| Large classification | Small classification | Weight |
|---|---|---|
| Traveling difficulty | Road width, the number of lanes | W31 |
| | Whether or not there is junction | W32 |
| | State of road shoulder (such as there is | W33 |
| | no cover on drainage channel) | |
| | Straightness (few carves) | W34 |

Furthermore, the negative score value is calculated in two cases of a case of manual driving on the travel route and a case of automatic driving. However, the weight is directly multiplied when the negative score value of the manual driving is calculated, and (1−weight) is multiplied when the negative score value of the automatic driving is calculated.

In the examples of Tables 4 and 5, NS31×(1−W31)+NS32×(1−W32)+NS33×(1−W33)+NS34×(1−W34).

Taking FIG. 8 as an example, negative scores at the time of automatic driving and manual driving in the sections of 8A→81, 8A→82, and 8A→84 are calculated. In this manner, the negative scores during the automatic driving and the manual driving are calculated between all the nodes of all the candidates for the travel route.

After the calculation is completed for all the candidates for the travel route to the destination, the travel route calculation unit 11 searches for a travel route having the minimum negative score value in step S304. This is a general optimization problem, and thus, it can be obtained by a known algorithm such as dynamic programming.

The route obtained by this processing is a travel route reflecting the priority information 24 set by the priority setting unit 23.

Note that, if part of the route between the nodes is a travel route on which automatic driving cannot be performed, the travel route may not be selected as automatic driving when the travel route is subsequently selected on the basis of the negative score, by setting the negative score in a case of automatic driving at the maximum value. In this case, driving may be switched from automatic driving to manual driving only between nodes where automatic driving cannot be performed, and driving may be switched from manual driving to automatic driving again when automatic driving becomes possible.

In addition, it is assumed that, for example, there are two travel routes and both routes have the same negative score, one route is a route on which driving between the nodes is alternately switched between automatic driving and manual driving (driving is frequently switched between automatic driving and manual driving), and the other route is a route on which places where automatic driving can be performed are concentrated (driving is not frequently switched between automatic driving and manual driving). In this case, for the user, the route on which driving is not frequently switched between automatic driving and manual driving is more preferable than the route on which driving is frequently switched between automatic driving and manual driving because driving operation is not complicated. In order to reflect the preference that does not appear in the negative score in the calculation method described so far in the negative score, a condition across a plurality of paths such as lowering the negative score in a case where automatic driving between the nodes is continuous may be added.

The automatic driving control unit 20 causes the vehicle to be automatically driven using the determined travel route, but the road conditions change from moment to moment. As a result, it can be assumed that the travel route determined as automatic driving becomes conditions where automatic driving is impossible due to, for example, a snowfall, a thunderstorm, an accident, or the like.

At that time, it is obvious that there will be a safety problem if the user cannot cope with the conditions, and thus, it is necessary to cope with the conditions.

In a case where an environmental change 9D has occurred on the scheduled travel route 82→87 as illustrated in FIG. 9, how to cope with the case in the present embodiment will be described.

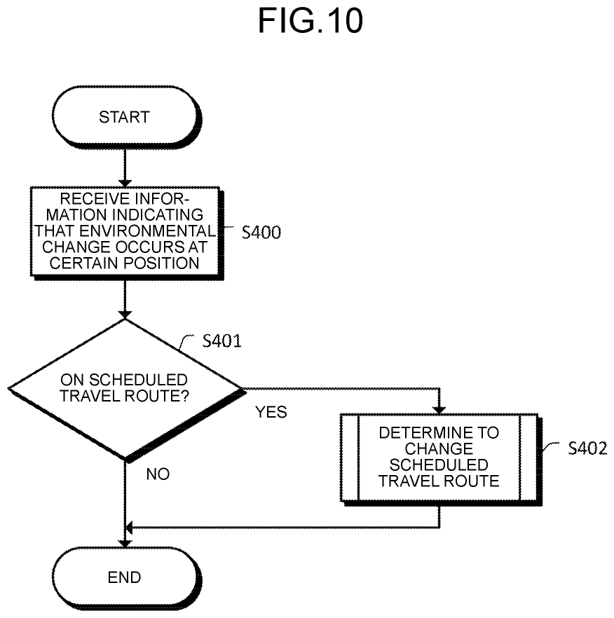

In the present embodiment, the information acquisition unit 18 constantly monitors whether an environmental change occurs on the scheduled travel route. FIG. 10 indicates flow in a case where an environmental change occurs. In S400, the travel route calculation unit 11 receives occurrence of an environmental change and a position thereof from the information acquisition unit 18. Whether the position is on the scheduled travel route and whether driving is to be switched from automatic driving to manual driving are determined in S401 using the received position and environmental change.

If the position is not on the scheduled travel route or if it is not an event of switching driving to manual driving, there is no change. If the position is on the scheduled travel route and it is an event of switching driving to manual driving, determination of change of the scheduled travel route is performed in step S402.

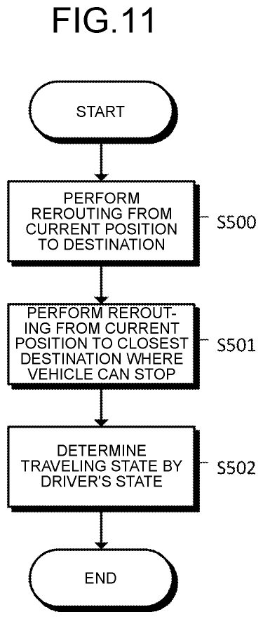

FIG. 11 indicates flow of the determination of the change of the scheduled travel route in step S402.

First, in step S500, the travel route calculation unit 11 performs rerouting from the current position to the destination in the same procedure as the travel route determination processing in FIG. 7. In this event, a travel route in which automatic driving is performed in all sections (between all nodes in the travel route) is also obtained. This is referred to as an automatic driving route. The travel route in which automatic driving is performed in all sections is obtained by searching only using the negative score during the automatic driving in the processing of searching for the travel route having the minimum negative score value in S304. However, there may be a case where there is no travel route on which automatic driving can be performed, and there is no solution for the automatic driving route. In addition, if automatic driving can be performed in all the sections of the best route, the automatic driving route is equal to the best route.

Subsequently, in S501, the travel route calculation unit 11 (also referred to as a destination setting unit) obtains a travel route on which automatic traveling can be performed to a place where the vehicle can stop registered in advance or a place where the vehicle can stop (such as a public parking lot) which can be determined from the map, which is different from the destination. This is defined as a route to a stop position. This can also be obtained by processing similar to the travel route determination processing in FIG. 7. Each route is represented as indicated in Table 6.

TABLE 6

| Priority | Negative | |
|---|---|---|
| order | score | Next traveling state |
| 0 | NSR0 | Best route (switch to manual driving) |
| 1 | NSR1 | Automatic driving route (travel while resetting |
| | | bypass route on which automatic driving is possible) |
| 2 | NSR2 | Route to stop position (move to place where vehicle |
| | | can stop and stop) |
| 3 | NSR3 | Stop at road shoulder on the spot |

Finally, in S502, the travel route calculation unit 11 determines a future travel route on the basis of the user state detected from the user state detection unit 22. The user state is classified as indicated in Table 7. The travel route is determined as follows.

TABLE 7

| Large classification | Small classification | Weight |
|---|---|---|
| State of driver | Dozing off | WD0 |
| | Doing another thing | WD1 |
| | Being awake | WD2 |

For example, in a case where the user is sleeping (not in a state of being able to drive) and there is an automatic driving route, the automatic driving route is selected. In a case where there is no automatic driving route and there is a route to the stop position, the route to the stop position is selected. In a case where there is no automatic driving route and there is no route to the stop position, the vehicle stops on the road shoulder.

Furthermore, for example, in a case where the user is doing another thing (a state where driving is possible if warning is given), the best route is selected. However, in a case where there is a manual driving section, a warning is issued. The warning may be issued by issuing warning sound with the speaker 122, or the like, of the information processing apparatus 100.

Further, for example, if the user is in a state of being able to drive, the best route is selected.

Then, in step S502, the travel route calculation unit 11 updates the current travel route to the selected travel route and performs automatic driving of the vehicle on the basis of the updated travel route.

### 2. Other Embodiments

Although one embodiment has been described above, the embodiment of the present disclosure is not limited thereto. For example, some functions of the information processing apparatus 100 may be implemented by a computer located far away via a network. Furthermore, a mobile terminal, or the like, possessed by the user may be connected to the vehicle, and part of the functions of the information processing apparatus 100 may be implemented by the connected mobile terminal, or the like.

Furthermore, in one embodiment, while the user state is acquired from an image capturing result of the camera 118 of the information processing apparatus 100, a method of grasping the user state is not limited thereto. For example, the user state may be grasped by the touch sensor 112 embedded in a steering wheel. Furthermore, physical information such as respiration and pulse of the user may be acquired by a sensor, and the user state may be grasped on the basis of the physical information.

In addition, in one embodiment, while the user manually sets the priority information 24 in the priority setting unit 23, a method of setting the priority is not limited thereto. For example, preference of the user may be analyzed from the past driving history of the user (frequency of selection of manual driving, history of travel route selection, history of travelling hours, history of steering wheel and brake operation, and the like), and the priority information 24 may be automatically calculated and set. Furthermore, in this event, driving histories of other users may be acquired via a network and referred to when analyzing the preference of the user.

In addition, in one embodiment, while the driving means priority including the preference of the driver is reflected in the travel route, the driving means priority is not limited to the driver. For example, a passenger of a taxi may set priority including his/her preference (for example, the user wants to arrive early even by using an expressway or wants to avoid a road with many curves because he/she gets carsick), and a taxi driver may drive the vehicle along a travel route based on the priority.

Further, in one embodiment, while the travel route is updated due to the environmental change 9D, the condition of updating the travel route is not limited thereto. For example, the travel route may be updated on the basis of a malfunction (failure, or the like,) of the vehicle or a state change (start sleeping, etc.) of the user.

Although the preferred embodiments of the present disclosure have been described in detail with reference to the accompanying drawings, the technical scope of the present disclosure is not limited to such examples. It is obvious that a person having ordinary knowledge in the technical field of the present disclosure can conceive various changes or modifications within the scope of the technical idea described in the claims, and it is naturally understood that these also belong to the technical scope of the present disclosure.

The above-described configuration illustrates an example of the present embodiment and naturally belongs to the technical scope of the present disclosure.

Furthermore, the effects described in the present specification are merely illustrative or exemplary and are not restrictive. In other words, the technology according to the present disclosure can exhibit other effects obvious to those skilled in the art from the description of the present specification together with or instead of the above effects.

Note that the following configurations also belong to the technical scope of the present disclosure.
(1)

An information processing apparatus including:

an information acquisition unit configured to acquire road information on each of two or more travel routes to a destination;

a priority acquisition unit configured to acquire priority of driving means in accordance with the road information; and

a selection unit configured to select one of the two or more travel routes on a basis of the road information and the priority.
(2)

The information processing apparatus according to (1), further including:

a travel route calculation unit configured to calculate two or more new travel routes from a current position of a vehicle to the destination in a case where change occurs in the road information acquired by the information acquisition unit while the vehicle is traveling along the selected travel route,

wherein the selection unit selects one of the two or more new travel routes on a basis of the road information after the change and the priority.
(3)

The information processing apparatus according to (2), further including:

a destination setting unit configured to set a position where the vehicle can stop, which is different from the destination as a new destination in a case where it is determined that safe traveling to the destination is impossible due to the change occurring in the road information,

wherein the travel route calculation unit calculates a new travel route to the new destination, and

the selection unit selects the new travel route.
(4)

The information processing apparatus according to any one of (1) to (3),

wherein the road information includes at least one of traffic congestion information, accident information, information on traffic regulations due to construction, a vehicle width, the number of lanes, the number of traffic lights, the number of intersections, whether or not a road is paved, whether or not a road surface is frozen, whether or not a road is covered with snow, and whether or not a road is covered with water.
(5)

The information processing apparatus according to any one of (1) to (4),

wherein the selection unit quantifies the road information on each of the two or more travel routes on a basis of the priority and selects one of the two or more travel routes on a basis of a value obtained by the quantification.
(6)

The information processing apparatus according to any one of (1) to (5),

wherein the priority is an index indicating whether a user desires automatic driving or manual driving in accordance with the road information.
(7)

The information processing apparatus according to any one of (1) to (6), further including:

a user state detection unit configured to detect a state of a user who is on a vehicle,

wherein the selection unit selects one of the two or more travel routes on a basis of the road information, the priority, and the state of the user.
(8)

A travel route determination method including:

acquiring road information on each of two or more travel routes to a destination;

acquiring priority of driving means in accordance with the road information; and

selecting one of the two or more travel routes on a basis of the road information and the priority.

### REFERENCE SIGNS LIST

11 TRAVEL ROUTE CALCULATION UNIT
12 GPS RECEPTION UNIT
14 CURRENT POSITION CALCULATION UNIT
15 DISPLAY UNIT
16 INPUT UNIT
17 MAP DATA ACQUISITION UNIT
18 INFORMATION ACQUISITION UNIT
19 COMMUNICATION UNIT
20 AUTOMATIC DRIVING CONTROL UNIT
21 DRIVE UNIT
22 USER STATE DETECTION UNIT
23 PRIORITY SETTING UNIT
24 PRIORITY INFORMATION
100 INFORMATION PROCESSING APPARATUS
102 CPU
104 GPU
106 RAM
108 VRAM
110 STORAGE
112 TOUCH SENSOR
114 DISPLAY
116 TRANSCEIVER
118 CAMERA
120 GPS RECEIVER
122 SPEAKER
124 BUS

1. An information processing apparatus including:
an information acquisition unit configured to acquire road information on each of two or more travel routes to a destination;
a priority acquisition unit configured to acquire priority of driving means in accordance with the road information; and
a selection unit configured to select one of the two or more travel routes on a basis of the road information and the priority.

2. The information processing apparatus according to claim 1, further including:
a travel route calculation unit configured to calculate two or more new travel routes from a current position of a vehicle to the destination in a case where change occurs in the road information acquired by the information acquisition unit while the vehicle is traveling along the selected travel route,
wherein the selection unit selects one of the two or more new travel routes on a basis of the road information after the change and the priority.

3. The information processing apparatus according to claim 2, further including:
a destination setting unit configured to set a position where the vehicle can stop, which is different from the destination as a new destination in a case where it is determined that safe traveling to the destination is impossible due to the change occurring in the road information,
wherein the travel route calculation unit calculates a new travel route to the new destination, and
the selection unit selects the new travel route.

4. The information processing apparatus according to claim 1,
wherein the road information includes at least one of traffic congestion information, accident information, information on traffic regulations due to construction, a vehicle width, the number of lanes, the number of traffic lights, the number of intersections, whether or not a road is paved, whether or not a road surface is frozen, whether or not a road is covered with snow, and whether or not a road is covered with water.

5. The information processing apparatus according to claim 1,
wherein the selection unit quantifies the road information on each of the two or more travel routes on a basis of the priority and selects one of the two or more travel routes on a basis of a value obtained by the quantification.

6. The information processing apparatus according to claim 1,
wherein the priority is an index indicating whether a user desires automatic driving or manual driving in accordance with the road information.

7. The information processing apparatus according to claim 1, further including:
a user state detection unit configured to detect a state of a user who is on a vehicle,
wherein the selection unit selects one of the two or more travel routes on a basis of the road information, the priority, and the state of the user.

8. A travel route determination method including:
acquiring road information on each of two or more travel routes to a destination;
acquiring priority of driving means in accordance with the road information; and
selecting one of the two or more travel routes on a basis of the road information and the priority.
